(19) United States
(12) Patent Application Publication
(10) Pub. No.: US 2024/0237047 A1
(43) Pub. Date: Jul. 11, 2024

(54) SCHEDULING CELL EDGE USERS TO AVOID CROSS LINK INTERFERENCE

(71) Applicant: Telefonaktiebolaget LM Ericsson (publ), Stockholm (SE)

(72) Inventors: Zaigham Kazmi, Austin, TX (US); Olav Queseth, Solna (SE)

(21) Appl. No.: 18/559,221

(22) PCT Filed: May 19, 2021
(86) PCT No.: PCT/IB2021/054338

§ 371 Date: Nov. 6, 2023

(51) Int. Cl. H04W 72/541; H04L 5/14; H04W 72/0446; H04W 72/566

(52) U.S. Cl. CPC H04W 72/541; H04L 5/1461; H04W 72/0446; H04W 72/566

(57) ABSTRACT

Systems and methods for avoiding or mitigating cross-link interference in a Time Division Duplexing (TDD) network are disclosed. In one embodiment, a method performed by a Radio Access Network (RAN) node comprises performing a baseline scheduling procedure for wireless communication devices for a slot, wherein the wireless communication devices are assigned first scheduling weights that correspond to priorities of the wireless communication devices for scheduling during the slot. The method further comprises determining that the slot is a downlink slot that is preceding an uplink slot and, responsive thereto, modifying the first scheduling weights based on whether the wireless communication devices are affected by cross-link interference to thereby provide second scheduling weights for the wireless communication devices for the slot. The method further comprises scheduling the wireless communication devices for the slot in accordance with the second scheduling weights.

### TECHNICAL FIELD

The present disclosure relates to mitigating Cross-Link Interference (CLI) in a cellular communications system.

### BACKGROUND

Cross-link interference (CLI) is very common in Time Division Duplexing (TDD) cellular networks which use the same frequency for both downlink and uplink. CLI occurs when either a base station of one cell interferes with a base station of another cell or when a User Equipment (UE) in one cell interferes with a UE in another cell. This is clear in the case of two opposing neighbor cells facing each other, as illustrated in the example of FIG. 1. FIG. 1 illustrates an example in which base station 100-1 controls a long range cell 102-1 and a base station 100-2 controls a short range cell 102-2. CLI occurs when, e.g., an uplink transmission from a UE 104-1, which is located near a boundary between the two cells 102-1 and 102, in the long range cell 102-1 that interferes with a downlink transmission to nearby UE 104-2 in the short range cell 102-2.

Two factors that influence CLI in a TDD network are gap symbols and timing advance. Gap symbols are symbols between downlink symbols and uplink symbols that are not configured for any transmission. Timing advance refers to the concept of a UE advancing its uplink transmission in time so that the uplink data from each of multiple UEs served by the same base station arrives at the base station at the same time irrespective of there being varying distances between the UEs and the base station. Thus, a UE that is further from the base station will start its uplink transmission earlier than a UE that is closer to the base station. In Third Generation Partnership Project (3GPP) Long Term Evolution (LTE) and New Radio (NR), a timing advance command is given by the base station to the UE with a Timing Advance (TA) value that is based on time of arrival of an uplink signal from the UE at the base station. As illustrated in FIG. 2, using a timing advance for an uplink transmission (e.g., on the Physical Uplink Shared Channel (PUSCH) in the example of FIG. 2) means that the UE will typically start its uplink transmission in gap symbols, hence the need for gap symbols. In FIG. 2, the TDD pattern is defined such that there are seven gap symbols between the end the downlink symbols/Physical Downlink Shared Channel (PDSCH) symbols in slot “x” and the start of the uplink/PUSCH symbols.

There are many different flavors of CLI, one of which is CLI due to the uplink of a UE in one cell interfering with the downlink of another UE in another cell. Typically, gap symbols protect against this kind of CLI. The number of gap symbols depends on the cell range supported by the cell. An example of uplink to downlink CLI is illustrated in FIG. 3.

If neighbor cells are configured to support different cell ranges, the number of gap symbols used would be different and, in this scenario, there is a higher likelihood of uplink from a UE in the larger cell interfering with the downlink from the base station to another UE in the smaller cell. For example, looking again FIG. 1, there is a higher likelihood of the uplink from the UE 104-1 in the long range cell 102-1 interfering with the downlink to the nearby UE 104-2 in the short range cell 102-2. In 3GPP NR, Frequency Range 2 (FR2) (high band) generally supports short range cells in the range of 500 meters (m) to 1,000 m. If a cell is configured to support a higher range (e.g., a cell size in the range of 2000 m to 7000 m), the cell would require high power UEs specially at the cell edge. In this case, the interference caused by the uplink of these high powered UEs at the cell boundary to the downlink of neighboring (short range) cells would be severe. This is illustrated in FIG. 1 in the case of an uplink from the high-powered UE 104-1 in the long range cell 102-1 causing server interference to the downlink to the nearby, normal UE 104-2 in the neighboring short range cell 102-2.

These high-powered UEs may be high-powered Fixed Wireless Access (FWA) devices, which will generally be installed in a fixed location such as, e.g., on the roof top of a building. Although these high-powered UEs are expected to have a directional antenna, there is still likelihood of radiation seeping backwards e.g., due to side- and back-lobes. The backwards radiation from these high-powered UEs installed on the rooftop would have line-of-sight (LOS) interference for the UEs at the edge of neighboring cells.

Most existing solutions for mitigating or avoiding CLI involve a base station determining when CLI might occur by learning the scheduling configuration of adjacent base stations and then reconfiguring its own scheduling configuration to avoid inter-cell interference. Some examples of such existing solutions are described in United States Patent Application Publication No. 2020/00205161 A1 entitled “Method and Base Station for Avoiding Inter-Cell Interference”, United States Patent Application Publication No. 2020/00313836 A1 entitled “System and Method for Distributed Coordination of Duplex Directions in a NR System”, and U.S. patent Ser. No. 10/396,967 B2 entitled “Method and Apparatus for Managing Downlink to Uplink Interference in Wireless Communication System.” U.S. patent Ser. No. 10/396,967 B2 describes a solution in which a base station: (a) determines interference intensity by scheduling in conflicting time/frequency resources and performing reference signal measurements, (b) exchanges interference information of each beam pair with adjacent base stations, and (c) allocates resources to avoid inter-cell interference. The base station may select frequency sub-band (beam index) based on interference information.

Another category of existing solutions for avoiding CLI do so via the use of reserved resources. In this category of solutions, a set of resources are reserved for use by one base station and cannot be used by other base stations. One example of this category of solutions is described in International Publication No. WO 2018/031746 A1 entitled “Long Term Evolution (LTE) and New Radio Coexistence with Reserved Resource Scheduling.”

Another approach is to detect CLI and then indicate this to the aggressor node (i.e., the node causing the interference). An example of this approach is described in International Publication No. WO 2018/231127 A1 entitled “Cross-Link Interference Avoidance Methods and Signaling in NR Dynamic TDD.”

All of the aforementioned solutions incur signaling overhead and are not efficient as some of the resources are wasted.

### SUMMARY

Systems and methods for avoiding or mitigating cross-link interference in a Time Division Duplexing (TDD) network are disclosed. In one embodiment, a method performed by a Radio Access Network (RAN) node for avoiding or mitigating cross-link interference in a TDD system comprises performing a baseline scheduling procedure for a plurality of wireless communication devices for a slot, wherein the plurality of wireless communication devices are assigned first scheduling weights during the baseline scheduling procedure that correspond to priorities of the wireless communication devices for scheduling during the slot. The method further comprises determining that the slot is a downlink slot that is preceding an uplink slot and, responsive thereto, modifying the first scheduling weights for the plurality of wireless communication devices for the slot based on whether wireless communication devices from among the plurality of wireless communication devices are affected by cross-link interference to thereby provide second scheduling weights for the plurality of wireless communication devices for the slot. The method further comprises scheduling the plurality of wireless communication devices for the slot in accordance with the second scheduling weights. In this manner, a low-overhead scheme for avoiding or mitigating cross-link interference is provided.

In one embodiment, the second scheduling weights are such that wireless communication devices that are affected by cross-link interference are not scheduled in the slot, which is a downlink slot that is preceding an uplink slot.

In one embodiment, modifying the first scheduling weights for the plurality of wireless communication devices for the slot comprises determining, from among the plurality of wireless communication devices, a set of wireless communication devices that are affected by cross-link interference, ranking wireless communication devices in the set of wireless communication devices that are affected by cross-link interference, assigning CLI based scheduling factors to the wireless communication devices in the set based on the ranking, and applying the CLI based scheduling factors assigned to the wireless communication devices in the set to the first scheduling weights assigned to the wireless communication devices in the set to thereby provide the second scheduling weights for the wireless communication devices in the set. In one embodiment, the second scheduling weights for wireless communication devices, from among the plurality of wireless communication devices, that are not in the set are equal to the first scheduling weights for the wireless communication devices that are not in the set. In one embodiment, determining the set of wireless communication devices that are affected by cross-link interference comprises determining, from among the plurality of wireless communication devices, a second set of wireless communication devices that are at a cell edge of a respective cell controlled by the RAN node. In one embodiment, the set of wireless communication devices that are affected by cross-link interference comprises the second set of wireless communication devices that are at the cell edge of the respective cell controlled by the RAN node.

In another embodiment, determining the set of wireless communication devices that are affected by cross-link interference further comprises determining, from among the second set of wireless communication devices that are at the cell edge, a third set of wireless communication devices that are at the cell edge and affected by cross-link interference, wherein the set of wireless communication devices that are affected by cross-link interference comprises the third set of wireless communication devices that are at the cell edge and affected by cross-link interference. In one embodiment, determining the third set of wireless communication devices that are at the cell edge and affected by cross-link interference comprises determining the third set of wireless communication devices that are at the cell edge based on comparisons of reception quality in downlink slots preceding uplink slots and reception quality in downlink slots not preceding uplink slots. In one embodiment, reception quality is based on ACK rate or NACK rate.

In one embodiment, determining the set of wireless communication devices that are affected by cross-link interference comprises determining, from among the plurality of wireless communication devices, a second set of wireless communication devices that are using cell edge beams of a respective cell controlled by the RAN node. In one embodiment, the set of wireless communication devices that are affected by cross-link interference comprises the second set of wireless communication devices that are using cell edge beams of a respective cell controlled by the RAN node. In one embodiment, ranking the wireless communication devices in the set of wireless communication devices that are affected by cross-link interference comprises ranking the wireless communication devices in the set of wireless communication devices that are affected by cross-link interference based on: (a) distance from a radio transmitter of the RAN node in terms of whether the wireless communication devices are using cell edge beams or not, (b) time of arrival of a signal at the RAN node, (c) timing advance command value, (d) reference signal measurement(s), or (e) a combination of any two or more of (a)-(d).

In one embodiment, ranking the wireless communication devices in the set of wireless communication devices that are affected by cross-link interference comprises ranking the wireless communication devices in the set of wireless communication devices that are affected by cross-link interference based on an impact of cross-link interference to each of the wireless communication device in the set as determined based on: one or more channel related statistics when the wireless communication device is assigned a downlink slot preceding an uplink slot and one or more channel related statistics when the wireless communication device is assigned a downlink slot not preceding an uplink slot.

In one embodiment, determining the set of wireless communication devices that are affected by cross-link interference comprises determining the set of wireless communication devices that are affected by cross-link interference based on, for each wireless communication device in the plurality of wireless communication devices: one or more channel related statistics when the wireless communication device is assigned a downlink slot preceding an uplink slot and one or more channel related statistics when the wireless communication device is assigned a downlink slot not preceding an uplink slot.

Corresponding embodiments of a RAN node are also disclosed. In one embodiment, a RAN node for avoiding or mitigating cross-link interference in a TDD system is adapted to perform a baseline scheduling procedure for a plurality of wireless communication devices for a slot, wherein the plurality of wireless communication devices are assigned first scheduling weights during the baseline scheduling procedure that correspond to priorities of the wireless communication devices for scheduling during the slot. The RAN node is further adapted to determine that the slot is a downlink slot that is preceding an uplink slot and, responsive thereto, modify the first scheduling weights for the plurality of wireless communication devices for the slot based on whether wireless communication devices from among the plurality of wireless communication devices are affected by cross-link interference to thereby provide second scheduling weights for the plurality of wireless communication devices. The RAN node is further adapted to schedule the plurality of wireless communication devices for the slot in accordance with the second scheduling weights.

In one embodiment, a RAN node for avoiding or mitigating cross-link interference in a TDD system comprises processing circuitry configured to cause the RAN node to perform a baseline scheduling procedure for a plurality of wireless communication devices for a slot, wherein the plurality of wireless communication devices are assigned first scheduling weights during the baseline scheduling procedure that correspond to priorities of the wireless communication devices for scheduling during the slot. The processing circuitry is further configured to cause the RAN node to determine that the slot is a downlink slot that is preceding an uplink slot and, responsive thereto, modify the first scheduling weights for the plurality of wireless communication devices for the slot based on whether wireless communication devices from among the plurality of wireless communication devices are affected by cross-link interference to thereby provide second scheduling weights for the plurality of wireless communication devices. The processing circuitry is further configured to cause the RAN node to schedule the plurality of wireless communication devices for the slot in accordance with the second scheduling weights.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an example scenario in which Cross-Link Interference (CLI) may occur;

FIG. 2 illustrates an example of timing advance for uplink transmission;

FIG. 3 illustrates an example of uplink to downlink CLI;

FIG. 4 illustrates an example in which uplink to downlink CLI may be avoided by ensuring that wireless communication devices that are close to the cell edge and/or wireless communication devices that are otherwise affected by the CLI are not scheduled in downlink slots preceding uplink slots;

FIG. 5 illustrates one example of a cellular communications system in which embodiments of the present disclosure may be implemented;

FIG. 6 is a flow chart that illustrate a CLI avoidance scheduling procedure in accordance with an embodiment of the present disclosure;

FIG. 7 is a flow chart that illustrates step 606A of FIG. 6 in more detail in accordance with one embodiment of the present disclosure;

FIG. 8 is a flow chart that illustrates step 606A and step 606B of FIG. 6 in more detail in accordance with another embodiment of the present disclosure;

FIG. 9 illustrates an example of cell edge beams versus non-cell-edge beams;

FIGS. 10, 11, and 12 are schematic block diagrams of example embodiments of a RAN node;

FIGS. 13 and 14 are schematic block diagrams of example embodiments of a wireless communication device (WCD);

FIG. 15 illustrates a telecommunication network connected via an intermediate network to a host computer in accordance with some embodiments of the present disclosure;

FIG. 16 is a generalized block diagram of a host computer communicating via a base station with a UE over a partially wireless connection in accordance with some embodiments of the present disclosure;

FIG. 17 is a flowchart illustrating a method implemented in a communication system in accordance with one embodiment of the present disclosure;

FIG. 18 is a flowchart illustrating a method implemented in a communication system in accordance with one embodiment of the present disclosure;

FIG. 19 is a flowchart illustrating a method implemented in a communication system in accordance with one embodiment of the present disclosure; and

FIG. 20 is a flowchart illustrating a method implemented in a communication system in accordance with one embodiment of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

In some embodiments, a set Transmission Points (TPs) is a set of geographically co-located transmit antennas (e.g., an antenna array (with one or more antenna elements)) for one cell, part of one cell or one Positioning Reference Signal (PRS)-only TP. TPs can include base station (eNB) antennas, Remote Radio Heads (RRHs), a remote antenna of a base station, an antenna of a PRS-only TP, etc. One cell can be formed by one or multiple TPs. For a homogeneous deployment, each TP may correspond to one cell.

In some embodiments, a set of TRPs is a set of geographically co-located antennas (e.g., an antenna array (with one or more antenna elements)) supporting TP and/or Reception Point (RP) functionality.

Cell Edge: As used herein, the term “cell edge” is defined as the region near the cell boundary which is affected by Cross-Link Interference (CLI). The width of the cell edge depends on the interference being encountered.

Cell Edge Beam: As used herein, the term “cell edge beam” refer to a beam which is covering the cell edge.

Scheduling Weight: As used herein, the term “scheduling weight” refers to a weight given to a wireless communication device (e.g., a UE) for the purpose of scheduling. A wireless communication device with a larger scheduling weight is prioritized over a wireless communication device with a smaller scheduling weight.

Legacy Scheduling Procedure or Baseline Scheduling Procedure: As used herein, the term “legacy scheduling procedure” or “baseline scheduling procedure” refers to any existing or known scheduling procedure for scheduling downlink and uplink transmissions in a wireless communication system such as, e.g., a cellular communications system.

Cross-Link Interference Avoidance (CLIA) Scheduling Procedure: As used herein, the terms “cross-link interference avoidance scheduling procedure” or “CLI avoidance scheduling procedure” or “CLIA scheduling procedure” refers to any of the embodiments of the scheduling procedure described herein that takes into account CLI.

CLIA Scheduling Weight: As used herein, the term “CLIA scheduling weight” refers to a weight assigned to a wireless communication device (e.g., a UE) based on an extent to which it is affected by CLI (e.g., based on its location at or near the cell edge).

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

In cellular wireless communication (e.g., LTE or NR), a UE is scheduled by the Radio Access Network (RAN) for both uplink and downlink data transmission. A number of different scheduling algorithms exist with different goals, i.e., to maximize cell throughput, to meet users' guaranteed throughput, to optimize overall throughput, etc. These scheduling algorithms take into account different parameters such as, e.g., UEs' Signal to Interference plus Noise Ratio (SINR), UEs' Quality of Service (QoS) requirements, cell bandwidth, etc.

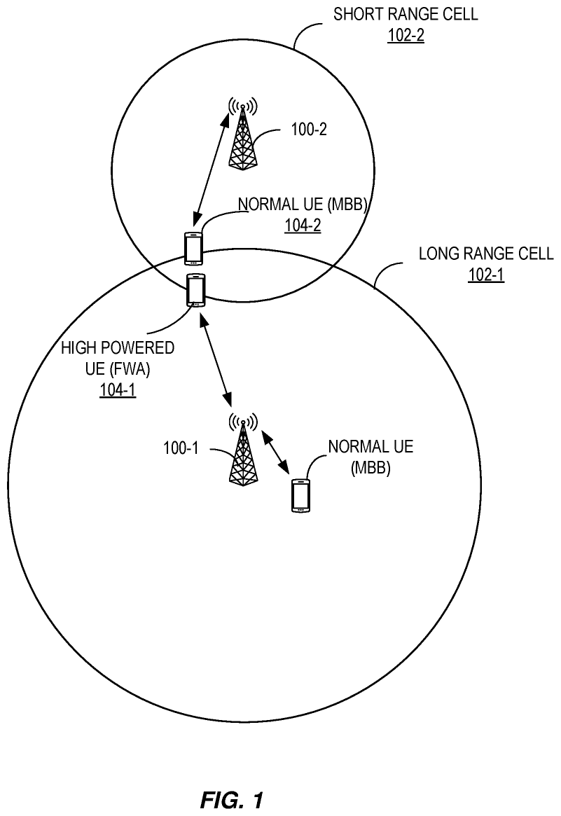

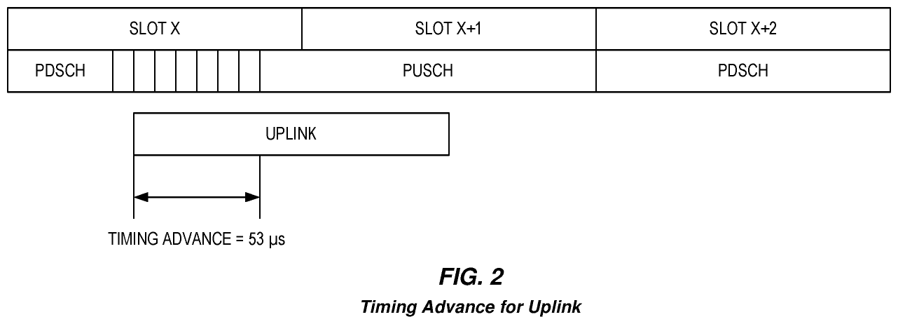

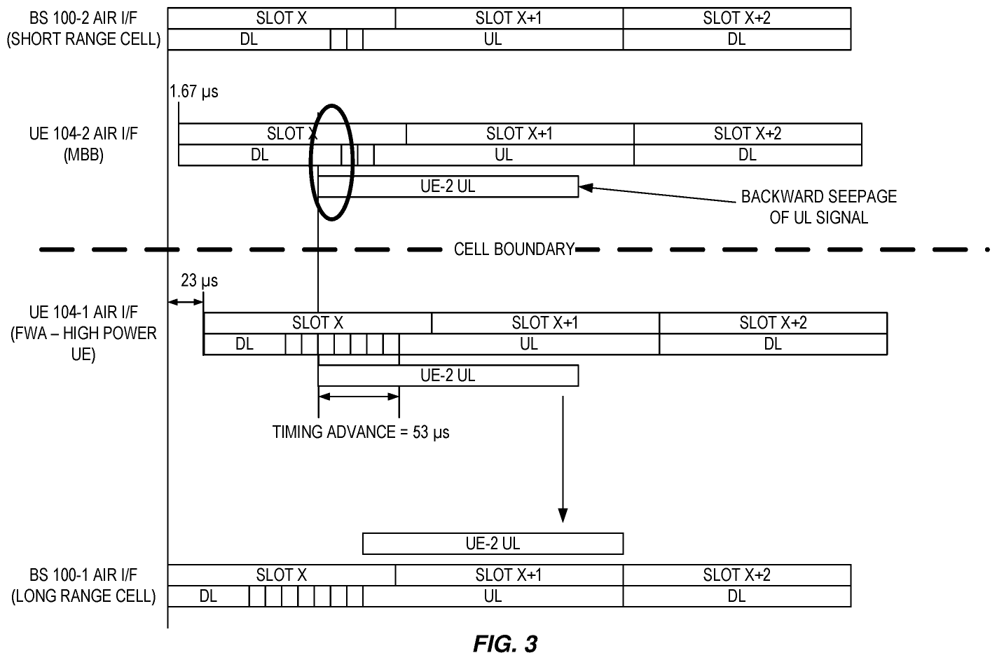

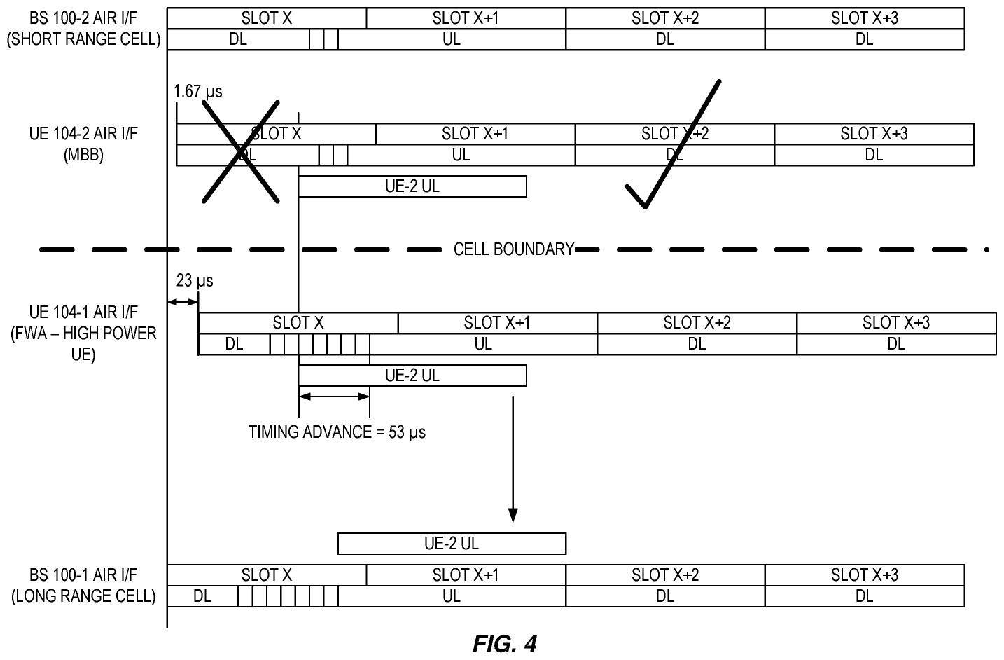

Systems and methods are disclosed herein for avoiding or mitigating CLI caused by an uplink transmission from a wireless communication device (e.g., a UE) in one cell interfering with a downlink transmission to a nearby wireless communication device (e.g., a UE) in a neighboring cell by using a scheduling procedure that considers cell edge wireless communication devices and downlink-to-uplink (DL-UL) CLI when making scheduling decisions. In one embodiment, wireless communication devices that are close to the cell edge and/or wireless communication devices that are otherwise affected by the CLI are not scheduled in downlink slots that precede uplink slots. For example, looking again at the example of FIG. 1, one option to avoid such CLI is to not schedule the UE 104-2 in the short range cell 102-2 in downlink slots preceding uplink slots (e.g., uplink slots used for an uplink transmission from the high-powered UE 104-1 in the long range cell 102-1). This is illustrated in FIG. 4.

Embodiments of the present disclosure may provide a number of advantages over the existing solutions for avoiding or mitigating CLI. For example, embodiment of the present disclosure may not require signaling between base stations to share TDD DL-UL configuration and/or scheduling information. As such, signaling overhead is reduced as compared to existing solutions. Further, the reduced or eliminated signaling means that the embodiments may be easier to implement as compared to the existing solutions (e.g., the scheduling procedure disclosed herein may be implemented within the baseband unit of the base station). As another example, embodiments disclosed herein may more precisely target the wireless communication devices affected by CLI as compared to the existing solutions. For instance, the base station may know the target area of each beam within a cell and target wireless communication devices that are in a beam(s) that are covering the cell edge. In other words, by knowing the target area of each beam within the cell, the base station knows precisely which wireless communication devices are at the cell edge and thus are more prone to CLI. In some embodiments, Time of Arrival (ToA) is used as an estimate of a wireless communication device's distance from the base station. Using ToA further enhances location accuracy of wireless communication devices at the cell edge. Also, in some embodiments, reference signal (RS) measurements may further be used to optimize location accuracy.

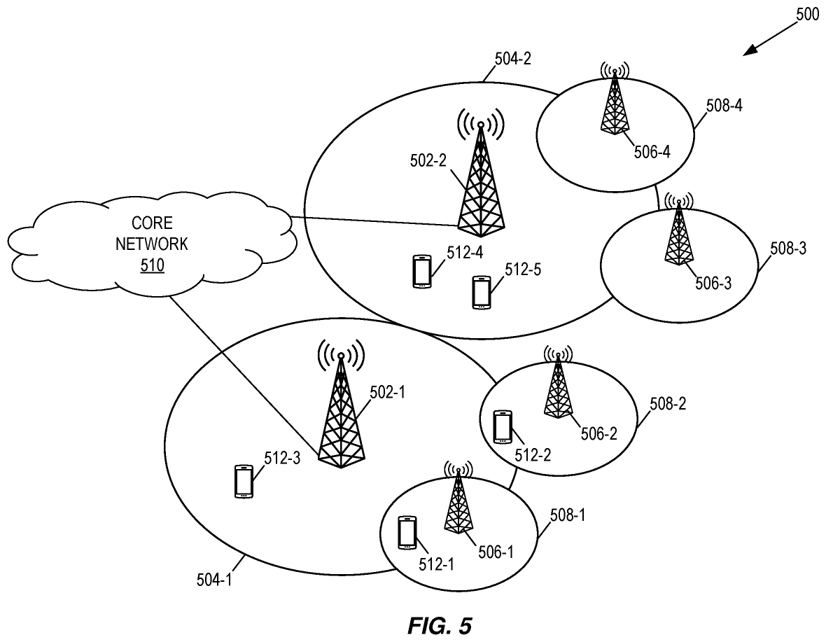

FIG. 5 illustrates one example of a cellular communications system 500 in which embodiments of the present disclosure may be implemented. In the embodiments described herein, the cellular communications system 500 is a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC). In this example, the RAN includes RAN nodes 502-1 and 502-2, which in the 5GS include NR base stations (gNBs) and optionally next generation eNBs (ng-eNBs) (e.g., LTE RAN nodes connected to the 5GC) and in the EPS include eNBs, controlling corresponding (macro) cells 504-1 and 504-2. The RAN nodes 502-1 and 502-2 are generally referred to herein collectively as RAN nodes 502 and individually as RAN node 502. Likewise, the (macro) cells 504-1 and 504-2 are generally referred to herein collectively as (macro) cells 504 and individually as (macro) cell 504. The RAN may also include a number of low power nodes 506-1 through 506-4 controlling corresponding small cells 508-1 through 508-4. The low power nodes 506-1 through 506-4 can be small base stations (such as pico or femto base stations) or RRHs, or the like. Notably, while not illustrated, one or more of the small cells 508-1 through 508-4 may alternatively be provided by the RAN nodes 502. The low power nodes 506-1 through 506-4 are generally referred to herein collectively as low power nodes 506 and individually as low power node 506. Likewise, the small cells 508-1 through 508-4 are generally referred to herein collectively as small cells 508 and individually as small cell 508. The cellular communications system 500 also includes a core network 510, which in the 5GS is referred to as the 5GC and in the EPS is referred to as the EPC. The RAN nodes 502 (and optionally the low power nodes 506) are connected to the core network 510.

The RAN nodes 502 and the low power nodes 506 provide service to wireless communication devices 512-1 through 512-5 in the corresponding cells 504 and 508. The wireless communication devices 512-1 through 512-5 are generally referred to herein collectively as wireless communication devices 512 and individually as wireless communication device 512. In the following description, the wireless communication devices 512 are oftentimes UEs and as such are sometimes referred to herein as UEs, but the present disclosure is not limited thereto.

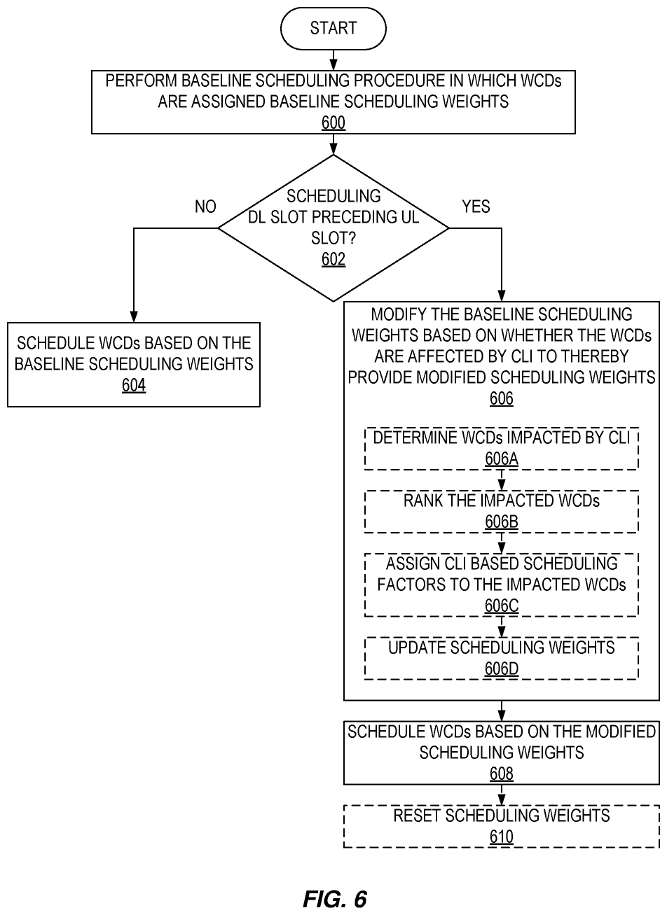

FIG. 6 is a flow chart that illustrates the operation of a RAN node 502 to perform a ‘Cross-link Interference Avoidance’ (CLIA) scheduling procedure in accordance with one embodiment of the present disclosure. Optional steps are represented by dashed lines/boxes. The RAN node 502 may be a base station (e.g., an eNB or gNB) or a unit, or component, of a base station when the base station is implemented using a split architecture such as, e.g., a Centralized Unit (CU)/Distributed Unit (DU) split architecture. For the case of a gNB having a split CU/DU architecture, the RAN node 502 may be the CU of the gNB (i.e., the gNB-CU).

The following terms refer to operations performed in at least some embodiments of the procedure of FIG. 6.
P_ADD refers to an operation that results in increased priority (e.g., increased scheduling weight). It could be a mathematical addition or multiplication or could be implemented in other ways as well.
   When using addition: P_ADD(x,y)==x+y
   When using multiplication: P_ADD(x,y)==x*y
Unity when applied to a scheduling weight refers to a value that does not change the scheduling weight.
   If P_ADD is being implemented as addition, Unity would imply zero (w=0).
   If P_ADD is being implemented as multiplication, Unity would imply one (w=1).
   Negative when applied to a scheduling weight refers to a value that will lower the overall scheduling priority.
   If P_ADD is being implemented as addition, Negative would imply negative number (w<0).
   If P_ADD is being implemented as multiplication, Negative would imply a fraction less than one (0>w>1).

The CLIA scheduling procedure of FIG. 6 works on top of an existing baseline scheduling procedure. The CLIA scheduling procedure of FIG. 6 includes the following steps:
Step 600: The RAN node 502 performs a baseline scheduling procedure for a slot. Using the baseline scheduling procedure, a scheduling weight—W_{b}(i)—is assigned to wireless communication devices 512 based on waiting period, QoS, channel condition, etc.
Step 602: The RAN node 502 determines whether the slot for which scheduling is being performed is a downlink slot that precedes an uplink slot.
Step 604: If the slot for which scheduling is being performed is not a downlink slot that precedes an uplink slot, the wireless communication devices 512 are scheduled in accordance with their baseline scheduling weights W_{b}(i).
Step 606: If the slot for which scheduling is being performed is a downlink slot that precedes an uplink slot, the RAN node 502 modifies the baseline scheduling weights W_{b}(i) for the wireless communication devices 512 based on whether the wireless communication devices 512 are affected by CLI. More specifically, step 606 includes the following:
   Step 606A: The RAN node 502 determines a set of wireless communication devices affected by CLI {U_{CLIA}}.
   Step 606B: The wireless communication devices 512 in the set {U_{CLIA}} are ranked according to the CLI expected by each wireless communication device 512 in the set {U_{CLIA}}.
      The more CLI expected, the higher the rank.
   Step 606C: RAN node 502 assigns CLIA based scheduling factors F_{CLIA}(i) to each wireless communication device 512.
      For wireless communication devices 512 not affected by CLI, i.e. wireless communication devices 512 not in the set {U_{CLIA}}, F_{CLIA} is set to UNITY
      For wireless communication devices affected by CLI, i.e. wireless communication devices 512 in the set {U_{CLIA}}, F_{CLIA} is set to a Negative value that is proportional to the amount of CLI expected for that wireless communication device 512.
      The higher the rank of the wireless communication device 512 in the set {U_{CLIA}}, the higher the absolute value of the Negative F_{CLIA} given to the wireless communication device 512.
   Step 606D: The RAN node 502 applies the assigned F_{CLIA}'s of the wireless communication devices 512 to the baseline scheduling weights of the wireless communication devices 512 to provide CLIA based scheduling weights W_{CLIA} for the wireless communication devices 512. In one embodiment, the assigned F_{CLIA}'s of the wireless communication devices 512 are applied to the baseline scheduling weights of the wireless communication devices 512 as follows:

$${W}_{CLIA} ( i ) = P\_ADD ( {W}_{b} ( i ) , {F}_{CLIA} ( i ) )$$

Step 608: The RAN node 502 schedules the wireless communication devices 512 according to the CLIA based scheduling weights W_{CLIA}.
Step 610: The RAN node 502 resets the scheduling weights of the wireless communication devices 512 in accordance with the baseline scheduling procedure, e.g., if the baseline scheduling procedure uses waiting period, it can be reset after wireless communication device 512 has been scheduled. In other words, the scheduling weights are reset, for example, if baseline algorithm uses ‘wait-based’ algorithm where weight is increased as long as wireless communication device 512 is not scheduled but, once wireless communication device 512 has been scheduled, its weight is reset. In step 610, weights are reset in accordance with the baseline scheduling procedure (e.g., scheduling weights for the wireless communication devices that have been scheduled are reset). Note, however, that if the baseline scheduling procedure does not reset the scheduling weights, then step 610 is not performed.

The procedure may then return to step 600 and be repeated for the next slot.

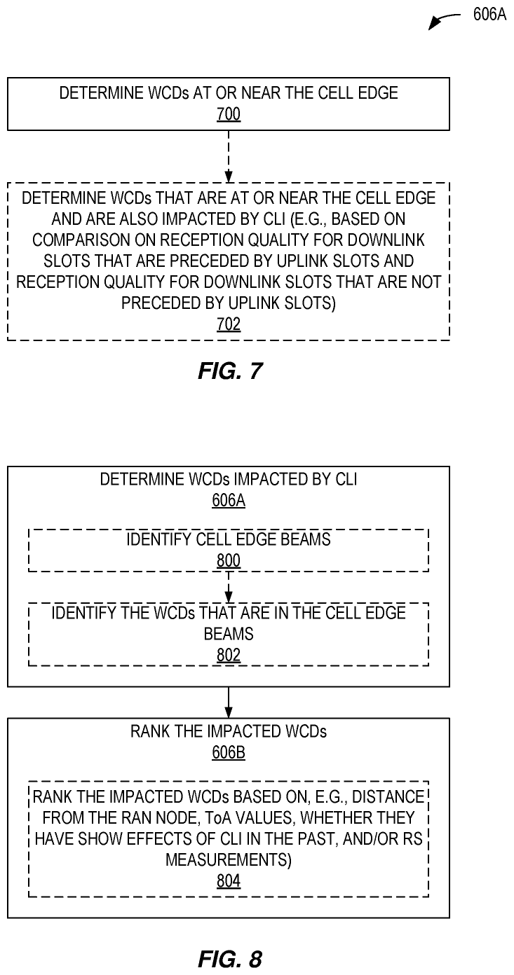

FIG. 7 is a flow chart that illustrates step 606A of FIG. 6 in more detail in accordance with one embodiment of the present disclosure. As illustrated, in order to determine the wireless communication devices 512 that are impacted by CLI (i.e., in order to determine the set {U_{CLIA}}), the RAN node 502 operates as follows:
Step 700: The RAN nodes 502 determines which of the wireless communication devices 512 are located at or near the cell edge. This may be done based on Time of Arrival (ToA) of uplink signals from the wireless communication devices 512, timing advance command values given to the wireless communication devices 512, beam being used for the wireless communication devices 512, signal strength reported by the wireless communication devices, or the like, or any combination thereof. In one embodiment, the wireless communication devices 512 determines as being at or near the cell edge are identified as the set {U_{CLIA}} of wireless communication devices impacted by CLI. However, in another embodiment, the RAN node 502 further performs step 702.
Step 702 (Optional): For the wireless communication devices 512 determined to be at or near the cell edge, the RAN node 502 may then further determine whether those wireless communication devices 512 are affected by CLI. In one embodiment, for each of the wireless communication devices 512 determined to be at or near the cell edge, the RAN node 512 determines whether the wireless communication device 512 is affected by CLI based on a comparison of the reception quality for the wireless communication device 512 in downlink slots preceding uplink slots with the reception quality for the wireless communication device 512 in downlink slots that do not precede uplink slots. In one embodiment, the reception quality is determined based on Acknowledgement (ACK) rate or Negative ACK (NACK) rate for the wireless communication device 512. The wireless communication devices 512 that are determined to be at or near the cell edge and also determined to be impacted by CLI are included in the set {U_{CLIA}}.

FIG. 8 is a flow chart that illustrates steps 606A and 606B in more detail in accordance with another embodiment of the present disclosure. As illustrated, in order to determine which wireless communication devices 512 are affected by CLI (step 606A) and rank the wireless communication devices 512 that are affected by CLI (step 606B), the RAN node 502 may perform any one or any combination of the following:
Step 800: The RAN node 502 identifies the beams that are covering the cell edge as B_{CE}(i). These beams could be wide beams or a set of narrow beams covering the cell edge. FIG. 9 illustrates one example of cell edge beams versus non-cell edge beams.
Step 802: The RAN node 502 identifies wireless communication devices 512 in the cell edge beams B_{CE}(i) as the wireless communication devices 512 that are affected by CLI, i.e., identifies those wireless communication devices 512 as the set {U_{CLIA}}
Step 804: Within the set {U_{CLIA}}, the RAN node 502 ranks the wireless communication devices 512 in the order of expected amount of CLI. This may be done using any one or more of the following techniques:
   The wireless communication devices 512 within the set {U_{CLIA}} that are using beams that are closer to the RAN node 502 (e.g., beams closer to the gNB, rather than cell edge beams) may be ranked lower than the wireless communication devices 512 within the set {U_{CLIA}} that are in beams farther from the RAN node 502 (e.g., farther from the gNB).
   The wireless communication devices 512 within the set {U_{CLIA}} that have shorter Time of Arrival (ToA) may be ranked lower than the wireless communication devices 512 within the set {U_{CLIA}} that have longer ToAs.
   The wireless communication devices 512 within the set {U_{CLIA}} that have shown the effect of CLI in the past are ranked higher than wireless communication devices 512 within the set {U_{CLIA}} that have not shown the effect of CLI in the past.
   Reference Signal (RS) measurements may further be used to determine accuracy of a wireless communication device's location.

Considering an exemplary beam grid as shown in Table 1 below where the top row indicates Transmit (Tx) beams farthest from the radio transmitter of the RAN node 502 and the bottom row indicates the Tx beams closest to the radio transmitter of the RAN node 502. In accordance with the example shown in Table 1, the wireless communication devices 512 in beams 11-18 may be ranked lower than the wireless communication devices 512 in beams 1-8, the wireless communication devices 512 in beams 21-28 may be ranked lower than the wireless communication devices 512 in beams 11-18, and the wireless communication devices 512 in beams 31-38 may be ranked lower than the wireless communication devices 512 in beams 21-28.

TABLE 1
Grid of Beam (GoB) - 4 elevation and 8 azimuth

| | | | | | | | |
|---|---|---|---|---|---|---|---|
| 1 | 2 | 3 | 4 | 5 | 6 | 7 | 8 |
| 11 | 12 | 13 | 14 | 15 | 16 | 17 | 18 |
| 21 | 22 | 23 | 24 | 25 | 26 | 27 | 28 |
| 31 | 32 | 33 | 34 | 35 | 36 | 37 | 38 |

In one embodiment, in step 606C of FIG. 6, the RAN node 502 assigns the CLIA based scheduling factors F_{CLIA}(i) to each wireless communication device 512 in the set {U_{CLIA}} based on the ranking. In one embodiment, the higher the ranking, the more Negative F_{CLIA} is assigned.

In one embodiment, the ranking of the wireless communication devices 512 in the set {U_{CLI}} in step 606B of FIG. 6 or step 804 in FIG. 8 in based on the impact of CLI to those wireless communication devices 512. In one embodiment, the impact of CLI on each wireless communication device 512 (e.g., each wireless communication device 512 in the set {U_{CLI}}) is tracked (e.g., by the RAN node 502) by maintaining two sets of records of channel metrics for each downlink assignment on a per wireless communication device basis. For a particular wireless communication device 512, these two sets of records are:
1. RECORD_{CLI}: This record maintains various channel related statistics e.g., Acknowledgement (ACK) rate, Modulation and Coding Scheme (MCS) used, etc. when the wireless communication device 512 is assigned a downlink slot preceding an uplink slot.
2. RECORD_{non-CLI}: This record maintains various channel related statistics e.g., ACK rate, MCS used, etc. when the wireless communication device 512 is assigned a downlink slot that does not precede an uplink slot.
   If RECORD_{CLI}(i) for wireless communication device i (which may be denoted as wireless communication device 512-i) shows considerably worse channel condition than RECORD_{non-CLI}(i), this indicates that the wireless communication device 512-i is affected by CLI. In one embodiment, RECORD_{CLI} may be used to rank the wireless communication devices 512 in the set {U_{CLI}}. The wireless communication devices 512 affected more by CLI are ranked higher. The CLI records for the wireless communication device 512-i may be deleted once the wireless communication device 512-i has moved out of set {U_{CLI}}

While the description above describes embodiments in which the two records are used to determine the extent to which the wireless communication devices 512 are impacted by CLI and thus to rank the wireless communication devices 512 in the set {U_{CLI}}, these records may additionally or alternatively be used to identify the wireless communication devices 512 to be included in the set {U_{CLI}} (e.g., in step 606A of FIG. 6). For example, if RECORD_{CLI}(i) for wireless communication device 512-i shows considerably worse channel condition than RECORD_{nonCLI}(i), this indicates that the wireless communication device 512-i is affected by CLI and should therefore be included in the set {U_{CLI}}. For example, if the ACK rate in RECORD_{CLI} is less than the ACK rate in RECORD_{non-CLI} by a predefined or configured threshold amount, then the wireless communication device 512-i is determined to be affected by CLI and therefore included in the set {U_{CLI}}.

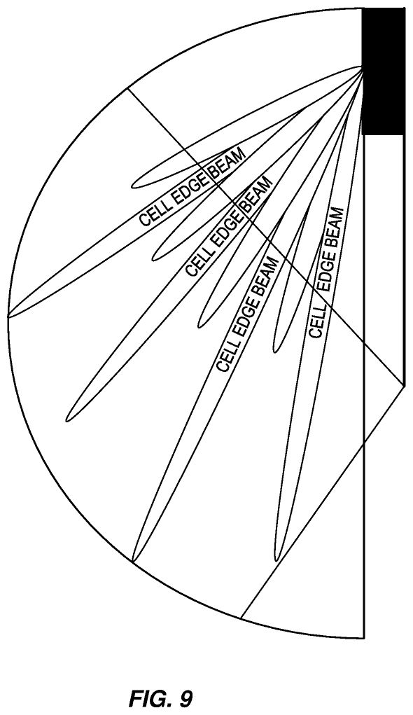

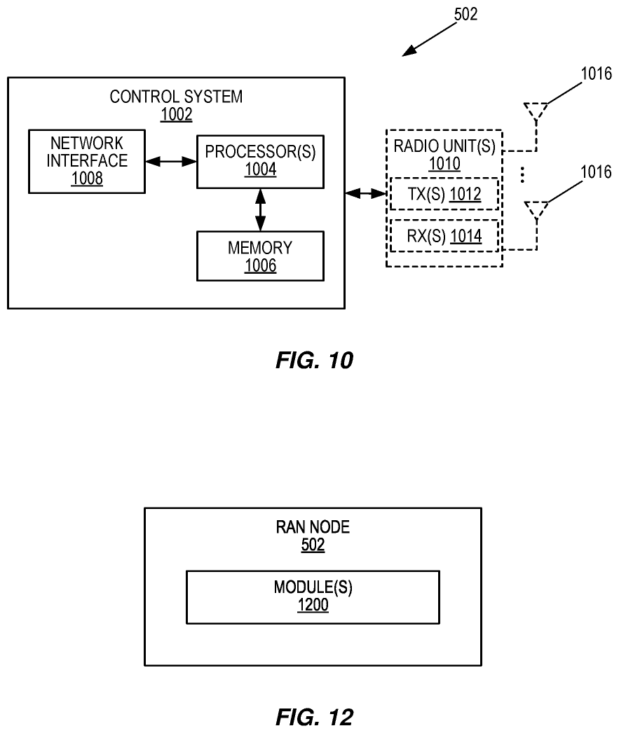

FIG. 10 is a schematic block diagram of the RAN node 502 according to some embodiments of the present disclosure. Optional features are represented by dashed boxes. As illustrated, the RAN node 502 includes a control system 1002 that includes one or more processors 1004 (e.g., Central Processing Units (CPUs), Application Specific Integrated Circuits (ASICs), Field Programmable Gate Arrays (FPGAs), and/or the like), memory 1006, and a network interface 1008. The one or more processors 1004 are also referred to herein as processing circuitry. In addition, the RAN node 502 may include one or more radio units 1010 that each includes one or more transmitters 1012 and one or more receivers 1014 coupled to one or more antennas 1016. The radio units 1010 may be referred to or be part of radio interface circuitry. In some embodiments, the radio unit(s) 1010 is external to the control system 1002 and connected to the control system 1002 via, e.g., a wired connection (e.g., an optical cable). However, in some other embodiments, the radio unit(s) 1010 and potentially the antenna(s) 1016 are integrated together with the control system 1002. The one or more processors 1004 operate to provide one or more functions of the RAN node 502 as described herein. In some embodiments, the function(s) are implemented in software that is stored, e.g., in the memory 1006 and executed by the one or more processors 1004.

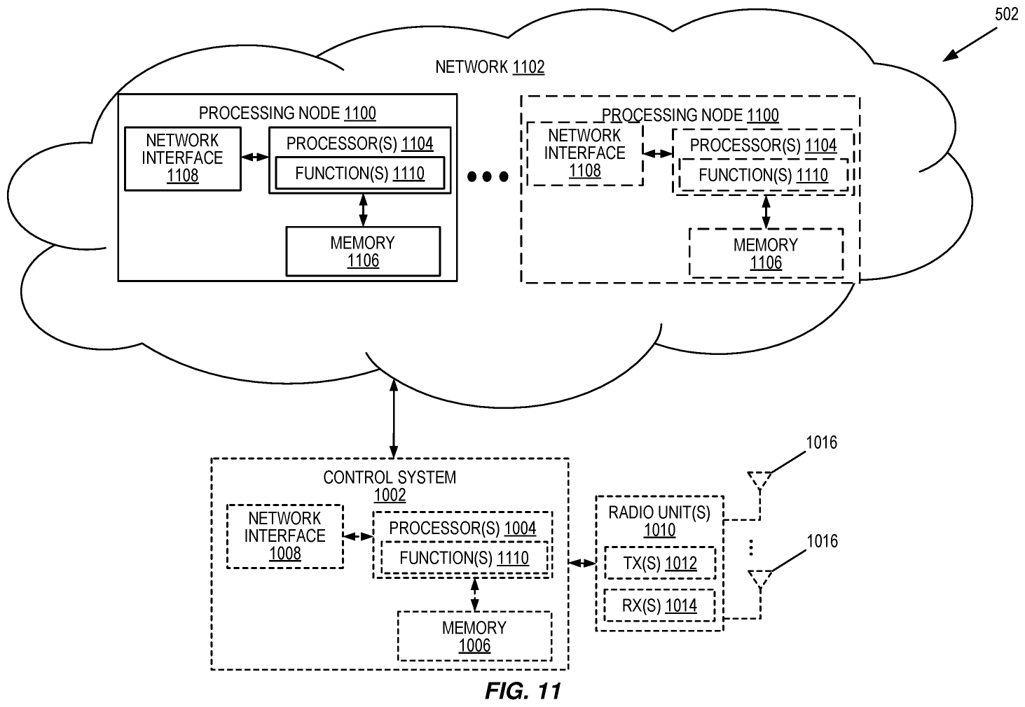

FIG. 11 is a schematic block diagram that illustrates a virtualized embodiment of the RAN node 502 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the RAN node 502 in which at least a portion of the functionality of the RAN node 502 is implemented as a virtual component(s) (e.g., via a virtual machine(s) executing on a physical processing node(s) in a network(s)). As illustrated, in this example, the RAN node 502 may include the control system 1002 and/or the one or more radio units 1010, as described above. The control system 1002 may be connected to the radio unit(s) 1010 via, for example, an optical cable or the like. The RAN node 502 includes one or more processing nodes 1100 coupled to or included as part of a network(s) 1102. If present, the control system 1002 or the radio unit(s) are connected to the processing node(s) 1100 via the network 1102. Each processing node 1100 includes one or more processors 1104 (e.g., CPUs, ASICs, FPGAs, and/or the like), memory 1106, and a network interface 1108.

In this example, functions 1110 of the RAN node 502 described herein are implemented at the one or more processing nodes 1100 or distributed across the one or more processing nodes 1100 and the control system 1002 and/or the radio unit(s) 1010 in any desired manner. In some particular embodiments, some or all of the functions 1110 of the RAN node 502 described herein are implemented as virtual components executed by one or more virtual machines implemented in a virtual environment(s) hosted by the processing node(s) 1100. As will be appreciated by one of ordinary skill in the art, additional signaling or communication between the processing node(s) 1100 and the control system 1002 is used in order to carry out at least some of the desired functions 1110. Notably, in some embodiments, the control system 1002 may not be included, in which case the radio unit(s) 1010 communicate directly with the processing node(s) 1100 via an appropriate network interface(s).

In some embodiments, a computer program including instructions which, when executed by at least one processor, causes the at least one processor to carry out the functionality of RAN node 502 or a node (e.g., a processing node 1100) implementing one or more of the functions 1110 of the RAN node 502 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 12 is a schematic block diagram of the RAN node 502 according to some other embodiments of the present disclosure. The RAN node 502 includes one or more modules 1200, each of which is implemented in software. The module(s) 1200 provide the functionality of the RAN node 502 described herein. This discussion is equally applicable to the processing node 1100 of FIG. 11 where the modules 1200 may be implemented at one of the processing nodes 1100 or distributed across multiple processing nodes 1100 and/or distributed across the processing node(s) 1100 and the control system 1002.

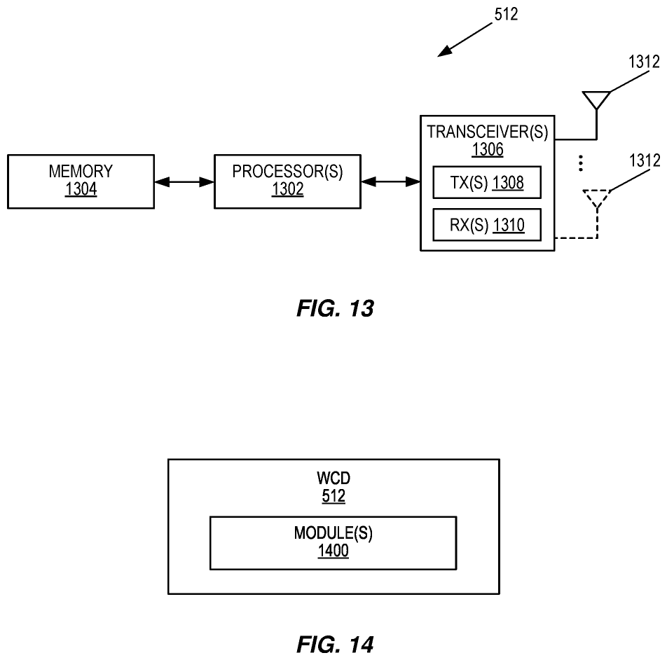

FIG. 13 is a schematic block diagram of a wireless communication device 512 according to some embodiments of the present disclosure. As illustrated, the wireless communication device 512 includes one or more processors 1302 (e.g., CPUs, ASICs, FPGAs, and/or the like), memory 1304, and one or more transceivers 1306 each including one or more transmitters 1308 and one or more receivers 1310 coupled to one or more antennas 1312. The transceiver(s) 1306 includes radio-front end circuitry connected to the antenna(s) 1312 that is configured to condition signals communicated between the antenna(s) 1312 and the processor(s) 1302, as will be appreciated by on of ordinary skill in the art. The processors 1302 are also referred to herein as processing circuitry. The transceivers 1306 are also referred to herein as radio circuitry. In some embodiments, the functionality of the wireless communication device 512 described above may be fully or partially implemented in software that is, e.g., stored in the memory 1304 and executed by the processor(s) 1302. Note that the wireless communication device 512 may include additional components not illustrated in FIG. 13 such as, e.g., one or more user interface components (e.g., an input/output interface including a display, buttons, a touch screen, a microphone, a speaker(s), and/or the like and/or any other components for allowing input of information into the wireless communication device 512 and/or allowing output of information from the wireless communication device 512), a power supply (e.g., a battery and associated power circuitry), etc.

In some embodiments, a computer program including instructions which, when executed by at least one processor, causes the at least one processor to carry out the functionality of the wireless communication device 512 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 14 is a schematic block diagram of the wireless communication device 512 according to some other embodiments of the present disclosure. The wireless communication device 512 includes one or more modules 1400, each of which is implemented in software. The module(s) 1400 provide the functionality of the wireless communication device 512 described herein.

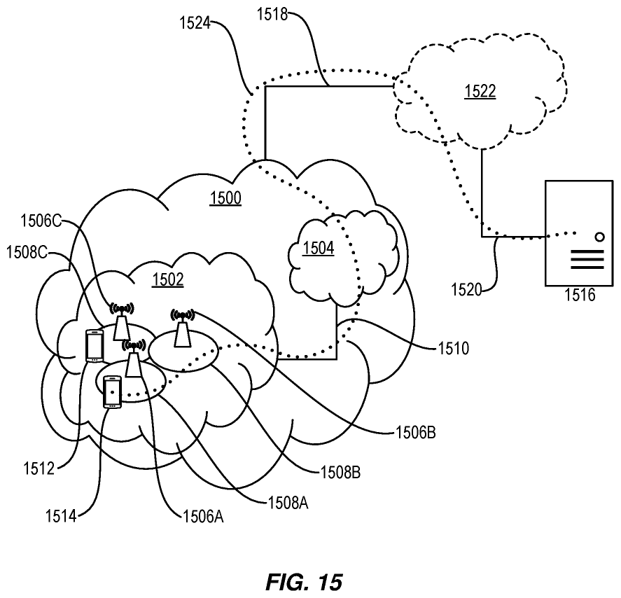

With reference to FIG. 15, in accordance with an embodiment, a communication system includes a telecommunication network 1500, such as a 3GPP-type cellular network, which comprises an access network 1502, such as a RAN, and a core network 1504. The access network 1502 comprises a plurality of base stations 1506A, 1506B, 1506C, such as Node Bs, eNBs, gNBs, or other types of wireless Access Points (APs), each defining a corresponding coverage area 1508A, 1508B, 1508C. Each base station 1506A, 1506B, 1506C is connectable to the core network 1504 over a wired or wireless connection 1510. A first UE 1512 located in coverage area 1508C is configured to wirelessly connect to, or be paged by, the corresponding base station 1506C. A second UE 1514 in coverage area 1508A is wirelessly connectable to the corresponding base station 1506A. While a plurality of UEs 1512, 1514 are illustrated in this example, the disclosed embodiments are equally applicable to a situation where a sole UE is in the coverage area or where a sole UE is connecting to the corresponding base station 1506.

The telecommunication network 1500 is itself connected to a host computer 1516, which may be embodied in the hardware and/or software of a standalone server, a cloud-implemented server, a distributed server, or as processing resources in a server farm. The host computer 1516 may be under the ownership or control of a service provider, or may be operated by the service provider or on behalf of the service provider. Connections 1518 and 1520 between the telecommunication network 1500 and the host computer 1516 may extend directly from the core network 1504 to the host computer 1516 or may go via an optional intermediate network 1522. The intermediate network 1522 may be one of, or a combination of more than one of, a public, private, or hosted network; the intermediate network 1522, if any, may be a backbone network or the Internet; in particular, the intermediate network 1522 may comprise two or more sub-networks (not shown).

The communication system of FIG. 15 as a whole enables connectivity between the connected UEs 1512, 1514 and the host computer 1516. The connectivity may be described as an Over-the-Top (OTT) connection 1524. The host computer 1516 and the connected UEs 1512, 1514 are configured to communicate data and/or signaling via the OTT connection 1524, using the access network 1502, the core network 1504, any intermediate network 1522, and possible further infrastructure (not shown) as intermediaries. The OTT connection 1524 may be transparent in the sense that the participating communication devices through which the OTT connection 1524 passes are unaware of routing of uplink and downlink communications. For example, the base station 1506 may not or need not be informed about the past routing of an incoming downlink communication with data originating from the host computer 1516 to be forwarded (e.g., handed over) to a connected UE 1512. Similarly, the base station 1506 need not be aware of the future routing of an outgoing uplink communication originating from the UE 1512 towards the host computer 1516.

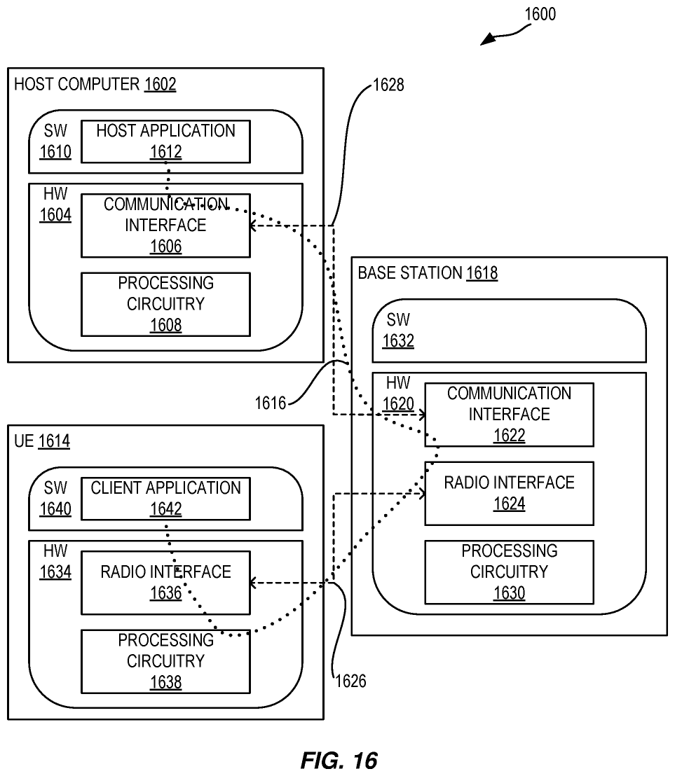

Example implementations, in accordance with an embodiment, of the UE, base station, and host computer discussed in the preceding paragraphs will now be described with reference to FIG. 16. In a communication system 1600, a host computer 1602 comprises hardware 1604 including a communication interface 1606 configured to set up and maintain a wired or wireless connection with an interface of a different communication device of the communication system 1600. The host computer 1602 further comprises processing circuitry 1608, which may have storage and/or processing capabilities. In particular, the processing circuitry 1608 may comprise one or more programmable processors, ASICs, FPGAs, or combinations of these (not shown) adapted to execute instructions. The host computer 1602 further comprises software 1610, which is stored in or accessible by the host computer 1602 and executable by the processing circuitry 1608. The software 1610 includes a host application 1612. The host application 1612 may be operable to provide a service to a remote user, such as a UE 1614 connecting via an OTT connection 1616 terminating at the UE 1614 and the host computer 1602. In providing the service to the remote user, the host application 1612 may provide user data which is transmitted using the OTT connection 1616.

The communication system 1600 further includes a base station 1618 provided in a telecommunication system and comprising hardware 1620 enabling it to communicate with the host computer 1602 and with the UE 1614. The hardware 1620 may include a communication interface 1622 for setting up and maintaining a wired or wireless connection with an interface of a different communication device of the communication system 1600, as well as a radio interface 1624 for setting up and maintaining at least a wireless connection 1626 with the UE 1614 located in a coverage area (not shown in FIG. 16) served by the base station 1618. The communication interface 1622 may be configured to facilitate a connection 1628 to the host computer 1602. The connection 1628 may be direct or it may pass through a core network (not shown in FIG. 16) of the telecommunication system and/or through one or more intermediate networks outside the telecommunication system. In the embodiment shown, the hardware 1620 of the base station 1618 further includes processing circuitry 1630, which may comprise one or more programmable processors, ASICs, FPGAs, or combinations of these (not shown) adapted to execute instructions. The base station 1618 further has software 1632 stored internally or accessible via an external connection.

The communication system 1600 further includes the UE 1614 already referred to. The UE's 1614 hardware 1634 may include a radio interface 1636 configured to set up and maintain a wireless connection 1626 with a base station serving a coverage area in which the UE 1614 is currently located. The hardware 1634 of the UE 1614 further includes processing circuitry 1638, which may comprise one or more programmable processors, ASICs, FPGAs, or combinations of these (not shown) adapted to execute instructions. The UE 1614 further comprises software 1640, which is stored in or accessible by the UE 1614 and executable by the processing circuitry 1638. The software 1640 includes a client application 1642. The client application 1642 may be operable to provide a service to a human or non-human user via the UE 1614, with the support of the host computer 1602. In the host computer 1602, the executing host application 1612 may communicate with the executing client application 1642 via the OTT connection 1616 terminating at the UE 1614 and the host computer 1602. In providing the service to the user, the client application 1642 may receive request data from the host application 1612 and provide user data in response to the request data. The OTT connection 1616 may transfer both the request data and the user data. The client application 1642 may interact with the user to generate the user data that it provides.

It is noted that the host computer 1602, the base station 1618, and the UE 1614 illustrated in FIG. 16 may be similar or identical to the host computer 1516, one of the base stations 1506A, 1506B, 1506C, and one of the UEs 1512, 1514 of FIG. 15, respectively. This is to say, the inner workings of these entities may be as shown in FIG. 16 and independently, the surrounding network topology may be that of FIG. 15.

In FIG. 16, the OTT connection 1616 has been drawn abstractly to illustrate the communication between the host computer 1602 and the UE 1614 via the base station 1618 without explicit reference to any intermediary devices and the precise routing of messages via these devices. The network infrastructure may determine the routing, which may be configured to hide from the UE 1614 or from the service provider operating the host computer 1602, or both. While the OTT connection 1616 is active, the network infrastructure may further take decisions by which it dynamically changes the routing (e.g., on the basis of load balancing consideration or reconfiguration of the network).

The wireless connection 1626 between the UE 1614 and the base station 1618 is in accordance with the teachings of the embodiments described throughout this disclosure. One or more of the various embodiments improve the performance of OTT services provided to the UE 1614 using the OTT connection 1616, in which the wireless connection 1626 forms the last segment.

A measurement procedure may be provided for the purpose of monitoring data rate, latency, and other factors on which the one or more embodiments improve. There may further be an optional network functionality for reconfiguring the OTT connection 1616 between the host computer 1602 and the UE 1614, in response to variations in the measurement results. The measurement procedure and/or the network functionality for reconfiguring the OTT connection 1616 may be implemented in the software 1610 and the hardware 1604 of the host computer 1602 or in the software 1640 and the hardware 1634 of the UE 1614, or both. In some embodiments, sensors (not shown) may be deployed in or in association with communication devices through which the OTT connection 1616 passes; the sensors may participate in the measurement procedure by supplying values of the monitored quantities exemplified above, or supplying values of other physical quantities from which the software 1610, 1640 may compute or estimate the monitored quantities. The reconfiguring of the OTT connection 1616 may include message format, retransmission settings, preferred routing, etc.; the reconfiguring need not affect the base station 1618, and it may be unknown or imperceptible to the base station 1618. Such procedures and functionalities may be known and practiced in the art. In certain embodiments, measurements may involve proprietary UE signaling facilitating the host computer's 1602 measurements of throughput, propagation times, latency, and the like. The measurements may be implemented in that the software 1610 and 1640 causes messages to be transmitted, in particular empty or ‘dummy’ messages, using the OTT connection 1616 while it monitors propagation times, errors, etc.

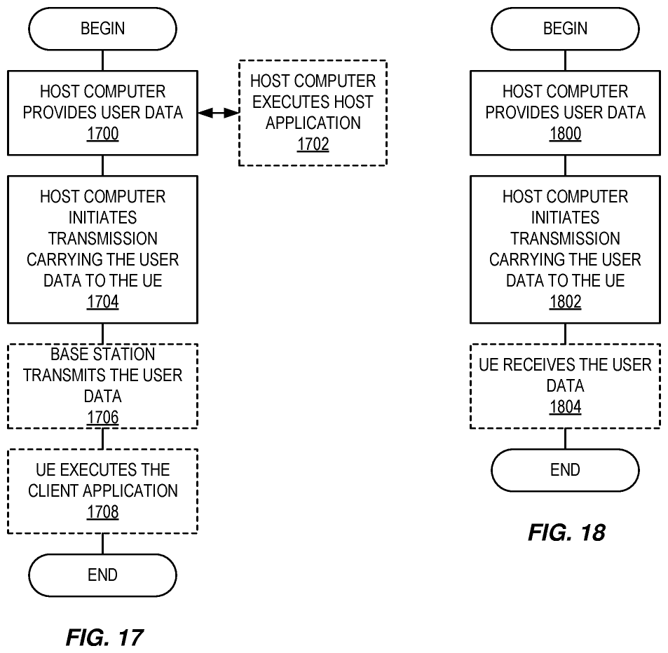

FIG. 17 is a flowchart illustrating a method implemented in a communication system, in accordance with one embodiment. The communication system includes a host computer, a base station, and a UE which may be those described with reference to FIGS. 15 and 16. For simplicity of the present disclosure, only drawing references to FIG. 17 will be included in this section. In step 1700, the host computer provides user data. In sub-step 1702 (which may be optional) of step 1700, the host computer provides the user data by executing a host application. In step 1704, the host computer initiates a transmission carrying the user data to the UE. In step 1706 (which may be optional), the base station transmits to the UE the user data which was carried in the transmission that the host computer initiated, in accordance with the teachings of the embodiments described throughout this disclosure. In step 1708 (which may also be optional), the UE executes a client application associated with the host application executed by the host computer.

FIG. 18 is a flowchart illustrating a method implemented in a communication system, in accordance with one embodiment. The communication system includes a host computer, a base station, and a UE which may be those described with reference to FIGS. 15 and 16. For simplicity of the present disclosure, only drawing references to FIG. 18 will be included in this section. In step 1800 of the method, the host computer provides user data. In an optional sub-step (not shown) the host computer provides the user data by executing a host application. In step 1802, the host computer initiates a transmission carrying the user data to the UE. The transmission may pass via the base station, in accordance with the teachings of the embodiments described throughout this disclosure. In step 1804 (which may be optional), the UE receives the user data carried in the transmission.

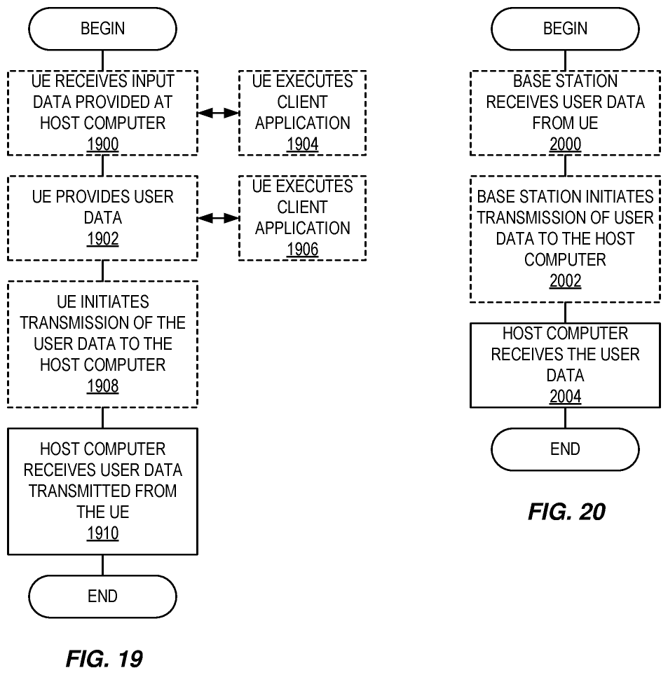

FIG. 19 is a flowchart illustrating a method implemented in a communication system, in accordance with one embodiment. The communication system includes a host computer, a base station, and a UE which may be those described with reference to FIGS. 15 and 16. For simplicity of the present disclosure, only drawing references to FIG. 19 will be included in this section. In step 1900 (which may be optional), the UE receives input data provided by the host computer. Additionally or alternatively, in step 1902, the UE provides user data. In sub-step 1904 (which may be optional) of step 1900, the UE provides the user data by executing a client application. In sub-step 1906 (which may be optional) of step 1902, the UE executes a client application which provides the user data in reaction to the received input data provided by the host computer. In providing the user data, the executed client application may further consider user input received from the user. Regardless of the specific manner in which the user data was provided, the UE initiates, in sub-step 1908 (which may be optional), transmission of the user data to the host computer. In step 1910 of the method, the host computer receives the user data transmitted from the UE, in accordance with the teachings of the embodiments described throughout this disclosure.

FIG. 20 is a flowchart illustrating a method implemented in a communication system, in accordance with one embodiment. The communication system includes a host computer, a base station, and a UE which may be those described with reference to FIGS. 15 and 16. For simplicity of the present disclosure, only drawing references to FIG. 20 will be included in this section. In step 2000 (which may be optional), in accordance with the teachings of the embodiments described throughout this disclosure, the base station receives user data from the UE. In step 2002 (which may be optional), the base station initiates transmission of the received user data to the host computer. In step 2004 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method performed by a Radio Access Network, RAN, node for avoiding or mitigating cross-link interference in a Time Division Duplexing, TDD, system, the method comprising:
performing a baseline scheduling procedure for a plurality of wireless communication devices for a slot, wherein the plurality of wireless communication devices are assigned first scheduling weights during the baseline scheduling procedure that correspond to priorities of the wireless communication devices for scheduling during the slot;
determining that the slot is a downlink slot that is preceding an uplink slot; responsive to determining that the slot is a downlink slot that is preceding an uplink slot:
modifying the first scheduling weights for the plurality of wireless communication devices for the slot based on whether wireless communication devices from among the plurality of wireless communication devices are affected by cross-link interference to thereby provide second scheduling weights for the plurality of wireless communication devices for the slot; and
scheduling the plurality of wireless communication devices for the slot in accordance with the second scheduling weights.

2. The method of claim 1 wherein the second scheduling weights are such that wireless communication devices that are affected by cross-link interference are not scheduled in the slot, which is a downlink slot that is preceding an uplink slot.

3. The method of claim 1 wherein modifying the first scheduling weights for the plurality of wireless communication devices for the slot comprises:
determining, from among the plurality of wireless communication devices, a set of wireless communication devices that are affected by cross-link interference;
ranking wireless communication devices in the set of wireless communication devices that are affected by cross-link interference;
assigning CLI based scheduling factors to the wireless communication devices in the set based on the ranking;
applying the CLI based scheduling factors assigned to the wireless communication devices in the set to the first scheduling weights assigned to the wireless communication devices in the set to thereby provide the second scheduling weights for the wireless communication devices in the set.

4. The method of claim 3 wherein the second scheduling weights for wireless communication devices, from among the plurality of wireless communication devices, that are not in the set are equal to the first scheduling weights for the wireless communication devices that are not in the set.

5. The method of claim 3 wherein determining, from among the plurality of wireless communication devices, the set of wireless communication devices that are affected by cross-link interference comprises:
determining, from among the plurality of wireless communication devices, a second set of wireless communication devices that are at a cell edge of a respective cell controlled by the RAN node.

6. The method of claim 5 wherein the set of wireless communication devices that are affected by cross-link interference comprises the second set of wireless communication devices that are at the cell edge of the respective cell controlled by the RAN node.

7. The method of claim 5 wherein determining, from among the plurality of wireless communication devices, the set of wireless communication devices that are affected by cross-link interference further comprises:
determining, from among the second set of wireless communication devices that are at the cell edge, a third set of wireless communication devices that are at the cell edge and affected by cross-link interference;
wherein the set of wireless communication devices that are affected by cross-link interference comprises the third set of wireless communication devices that are at the cell edge and affected by cross-link interference.

8. The method of claim 7 wherein determining the third set of wireless communication devices that are at the cell edge and affected by cross-link interference comprises determining the third set of wireless communication devices that are at the cell edge based on comparisons of reception quality in downlink slots preceding uplink slots and reception quality in downlink slots not preceding uplink slots.

9. The method of claim 8 wherein reception quality is based on ACK rate or NACK rate.

10. The method of claim 3 wherein determining, from among the plurality of wireless communication devices, the set of wireless communication devices that are affected by cross-link interference comprises:
determining, from among the plurality of wireless communication devices, a second set of wireless communication devices that are using cell edge beams of a respective cell controlled by the RAN node.

11. The method of claim 10 wherein the set of wireless communication devices that are affected by cross-link interference comprises the second set of wireless communication devices that are using cell edge beams of a respective cell controlled by the RAN node.

12. The method of claim 10 wherein ranking the wireless communication devices in the set of wireless communication devices that are affected by cross-link interference comprises ranking the wireless communication devices in the set of wireless communication devices that are affected by cross-link interference based on:
(a) distance from a radio transmitter of the RAN node in terms of whether the wireless communication devices are using cell edge beams or not;
(b) time of arrival of a signal at the RAN node;
(c) timing advance command value;
(d) reference signal measurement(s); or
(e) a combination of any two or more of (a)-(d).

13. The method of claim 3 wherein ranking the wireless communication devices in the set of wireless communication devices that are affected by cross-link interference comprises ranking the wireless communication devices in the set of wireless communication devices that are affected by cross-link interference based on an impact of cross-link interference to each of the wireless communication device in the set as determined based on:
one or more channel related statistics when the wireless communication device is assigned a downlink slot preceding an uplink slot; and
one or more channel related statistics when the wireless communication device is assigned a downlink slot not preceding an uplink slot.

14. The method of claim 1 wherein determining the set of wireless communication devices that are affected by cross-link interference comprises determining the set of wireless communication devices that are affected by cross-link interference based on, for each wireless communication device in the plurality of wireless communication devices:
one or more channel related statistics when the wireless communication device is assigned a downlink slot preceding an uplink slot; and
one or more channel related statistics when the wireless communication device is assigned a downlink slot not preceding an uplink slot.

15. A Radio Access Network, RAN, node for avoiding or mitigating cross-link interference in a Time Division Duplexing, TDD, system, the RAN node adapted to:
perform a baseline scheduling procedure for a plurality of wireless communication devices for a slot, wherein the plurality of wireless communication devices are assigned first scheduling weights during the baseline scheduling procedure that correspond to priorities of the wireless communication devices for scheduling during the slot;
determine that the slot is a downlink slot that is preceding an uplink slot;
responsive to determining that the slot is a downlink slot that is preceding an uplink slot:
modify the first scheduling weights for the plurality of wireless communication devices for the slot based on whether wireless communication devices from among the plurality of wireless communication devices are affected by cross-link interference to thereby provide second scheduling weights for the plurality of wireless communication devices for the slot; and
schedule the plurality of wireless communication devices for the slot in accordance with the second scheduling weights.

16. (canceled)

17. A Radio Access Network, RAN, node for avoiding or mitigating cross-link interference in a Time Division Duplexing, TDD, system, the RAN node comprising processing circuitry configured to cause the RAN node to:
perform a baseline scheduling procedure for a plurality of wireless communication devices for a slot, wherein the plurality of wireless communication devices are assigned first scheduling weights during the baseline scheduling procedure that correspond to priorities of the wireless communication devices for scheduling during the slot;
determine that the slot is a downlink slot that is preceding an uplink slot;
responsive to determining that the slot is a downlink slot that is preceding an uplink slot:
modify the first scheduling weights for the plurality of wireless communication devices for the slot based on whether wireless communication devices from among the plurality of wireless communication devices are affected by cross-link interference to thereby provide second scheduling weights for the plurality of wireless communication devices for the slot; and
schedule the plurality of wireless communication devices for the slot in accordance with the second scheduling weights.

18. The RAN node of claim 17 wherein the second scheduling weights are such that wireless communication devices that are affected by cross-link interference are not scheduled in the slot, which is a downlink slot that is preceding an uplink slot.

19. The RAN node of claim 17 wherein, in order to modify the first scheduling weights for the plurality of wireless communication devices for the slot, the processing circuitry is further configured to cause the RAN node to:
determine, from among the plurality of wireless communication devices, a set of wireless communication devices that are affected by cross-link interference;
rank wireless communication devices in the set of wireless communication devices that are affected by cross-link interference;
assign CLI based scheduling factors to the wireless communication devices in the set based on the ranking;
apply the CLI based scheduling factors assigned to the wireless communication devices in the set to the first scheduling weights assigned to the wireless communication devices in the set to thereby provide the second scheduling weights for the wireless communication devices in the set.

20. (canceled)
